(19) United States
(12) Patent Application Publication
(10) Pub. No.: US 2006/0201303 A1
(43) Pub. Date: Sep. 14, 2006

(54) Pressing mechanism of cutting apparatus

(75) Inventor: Tzu-Feng Tseng, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/106,331

(22) Filed: Apr. 14, 2005

(30) Foreign Application Priority Data
Mar. 11, 2005 (TW) 094107508

(51) Int. Cl. B26D 5/08

(52) U.S. Cl. 83/605

(57) ABSTRACT

A pressing mechanism of a cutting apparatus includes a pressing plate, at least two cams, a supporting member and a transmission member. The pressing plate member is disposed above an article supporting surface and adjacent to a trimmer of the cutting apparatus, wherein a receptacle is formed between the pressing plate member and the article supporting surface. The at least two cams are disposed above the pressing plate member and have respective protrusion posts protruded from the same side thereof. The supporting member is fixed on the article supporting surface for supporting the at least two cams and used as a fulcrum. The transmission member has a transmission rod pivotally coupled to the protrusion posts for driving the at least two cams to synchronously roll and be downwardly sustained against the pressing plate member, thereby pressing the sheet article accommodated within the receptacle and facilitating a further trimming operation on the sheet article.

### FIELD OF THE INVENTION

The present invention relates to a pressing mechanism, and more particularly to a pressing mechanism of a cutting apparatus.

### BACKGROUND OF THE INVENTION

Conventionally, the trimmer for trimming sheet articles such as papers, photographs, leathers or the like needs a pressing mechanism to firmly hold these sheet articles on a working platform. By means of the pressing mechanism, the risk of injuring a hand that holds the sheet articles during the trimming operation may be avoided. The pressing mechanism is also advantageous for assuring that the sheet articles will not be soiled or contaminated by the user's hand.

Since the pressing forces provided from many pressing mechanisms of the conventional cutting apparatuses are insufficient, the pressing mechanisms of the prior art fail to firmly hold the sheet articles and thus the cutting apparatuses are not safe for performing the trimming operations.

For increasing safety of using the cutting apparatus, there is a need to provide an improved pressing mechanism so as to effectively and safety trim the sheet articles.

### SUMMARY OF THE INVENTION

It is an object of the present invention to provide a pressing mechanism capable of offering a strong pressing force to hold the sheet articles so as to be applied to the cutting apparatus.

In accordance with a first aspect of the present invention, there is provided a pressing mechanism of a cutting apparatus. The cutting apparatus comprises a platform having an article supporting surface and a trimmer. The pressing mechanism comprises a pressing plate, at least two cams, a supporting member and a transmission member. The pressing plate member is disposed above the article supporting surface and adjacent to the trimmer, wherein a receptacle is formed between the pressing plate member and the article supporting surface so as to accommodate a sheet article. The at least two cams are disposed above the pressing plate member and have respective protrusion posts protruded from the same side thereof. The supporting member is fixed on the article supporting surface for supporting the at least two cams and used as a fulcrum such that the at least two cams are pivoted about the supporting member. The transmission member has a transmission rod pivotally coupled to the protrusion posts for driving the at least two cams to synchronously roll and allowing the at least two cams to be downwardly sustained against the pressing plate member, thereby pressing the sheet article accommodated within the receptacle and facilitating a further trimming operation on the sheet article.

In an embodiment, the trimmer is a knife, which has a first end coupled to a trimming edge of the platform and used as a fulcrum of the knife such that the knife is pivoted about the trimming edge.

In an embodiment, the knife further comprises a stem and a knife-edge. The stem is disposed at a second end of the knife. The knife-edge is disposed between the first and second ends of the knife, and in close contact with the trimming edge, wherein the knife-edge cooperates with the trimming edge to trim the sheet article when the stem is moved downwardly.

In an embodiment, the pressing plate member comprises an upper pressing plate and a lower pressing plate. The upper pressing plate has a plurality of openings to have corresponding screws penetrate therethrough. The lower pressing plate has a plurality of pillars corresponding to the screws. Each pillar has a bolt hole for a corresponding screw to insert therein.

In an embodiment, the pressing plate member further comprises a plurality of resilience elements disposed between the upper pressing plate and the lower pressing plate and sheathed around the pillars, wherein the resilience elements provide an elastic pressing effect when the at least two cams are downwardly sustained against the pressing plate member.

Preferably, the pillars are integrally formed with the lower pressing plate.

In an embodiment, the pressing plate member further comprises a rubber pad under the lower pressing plate.

In an embodiment, each cam comprises first and second cam parts, and a curved connection part. The first and second cam parts have first holes for a shaft to penetrate therethrough. The curved connection part is coupled to portions of the rolling surfaces of the first and cam parts, and integrally formed with the first and second cam parts so as to form hollow cams.

In an embodiment, the supporting member further comprises second holes, and each shaft penetrates through the first holes of each cam and the second holes of the supporting member so as to support the at least two cams and be used as a fulcrum such that the at least two cams are pivoted about the shaft.

In an embodiment, each cam is a solid cam having first holes for a shaft to penetrate therethrough.

In an embodiment, the supporting member further comprises two props disposed at bilateral sides thereof, adjacent to the pressing plate member, and fixed on the article supporting surface, wherein each of the two props is sheathed by a resilience element.

In an embodiment, the pressing plate member is movably clamped between the two props and supported by the two resilience elements. The pressing plate member moves downwardly along the two props to compress the two resilience elements when the at least two cams are sustained against the pressing plate member. The recovery elastic force generated from the compressed resilience elements uplifts the pressing plate member to the original state to expose the receptacle between the pressing plate member and the article supporting surface when the at least two cams have not been sustained against the pressing plate member.

In an embodiment, the transmission member further comprises a stirring handle pivotally coupled to either of the at least two cams. In response to an external force applying on the stirring handle, the transmission rod is driven to move in reciprocation and the rolling surfaces of the at least two cams are rolled on the pressing plate member back and forth.

In accordance with a second aspect of the present invention, there is provided cutting apparatus for trimming a sheet article. The cutting apparatus comprises a platform, a trimmer and a pressing mechanism. The platform has an article supporting surface for placing thereon the sheet article. The trimmer is disposed on a trimming edge of the platform. The pressing mechanism is disposed above the article supporting surface and adjacent to the trimmer, and comprises a pressing plate member, at least two cams and a transmission rod. A receptacle is formed between the pressing plate member and the article supporting surface so as to accommodate the sheet article. The at least two cams have respective protrusion posts protruded from the same side thereof. The transmission rod is pivotally coupled to the protrusion posts for driving the at least two cams to synchronously roll and allowing the at least two cams to be downwardly sustained against the pressing plate member, thereby pressing the sheet article accommodated within the receptacle and facilitating a further trimming operation on the sheet article.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(A) is a schematic assembling diagram of a cutting apparatus according to a preferred embodiment of the present invention;

FIG. 1(B) is a schematic exploded diagram of the cutting apparatus in FIG. 1(A);

FIG. 2(A) is a schematic exploded diagram of a pressing mechanism according to a preferred embodiment of the present invention;

FIG. 2(B) is a schematic assembling diagram of the pressing mechanism in FIG. 2(A);

FIG. 3(A) is a schematic side diagram of the cutting apparatus illustrating that the two cams have not been sustained against the pressing plate member to perform the pressing operation; and

FIG. 3(B) is a schematic side diagram of the cutting apparatus illustrating that the two cams have been sustained against the pressing plate member to perform the pressing operation.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

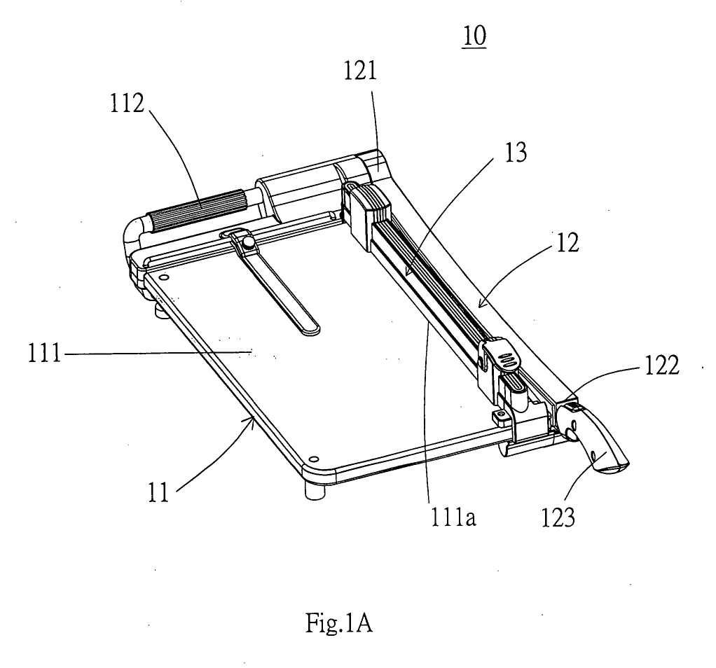

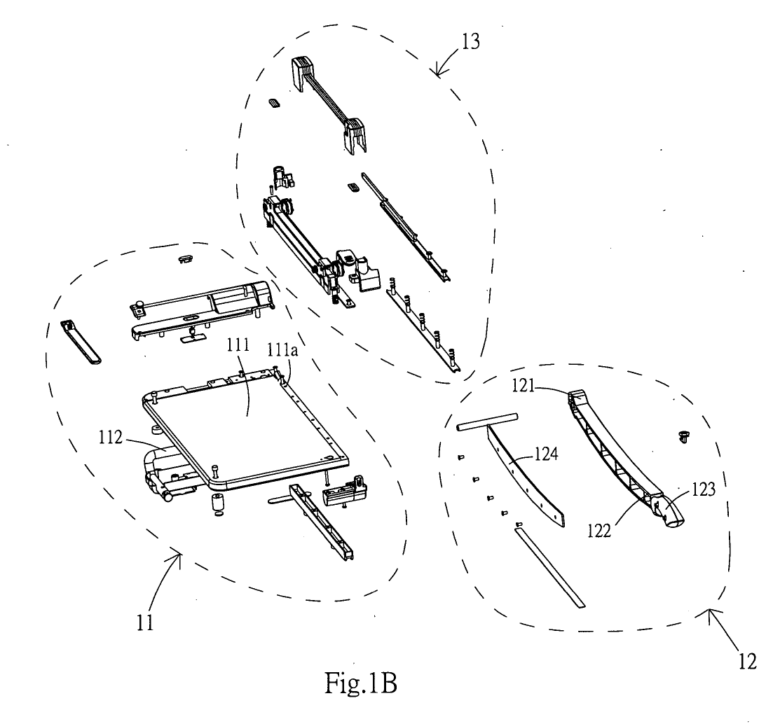

Please refer to FIGS. 1(A) and 1(B), which are an assembling diagram and an exploded diagram of a cutting apparatus according a preferred embodiment of the present invention, respectively.

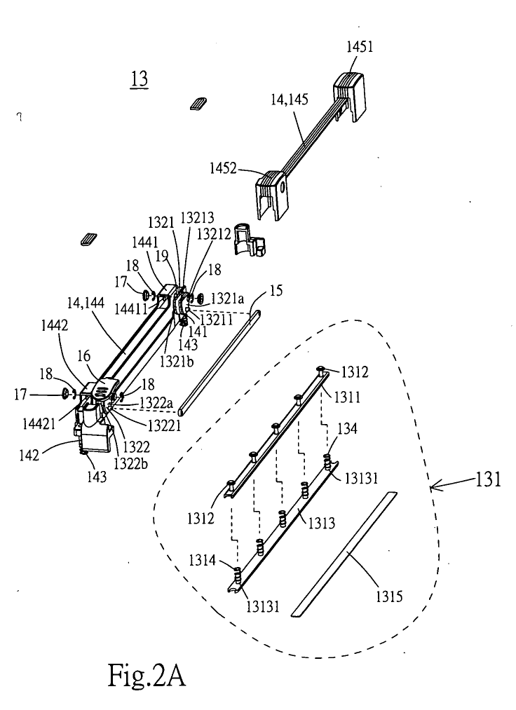

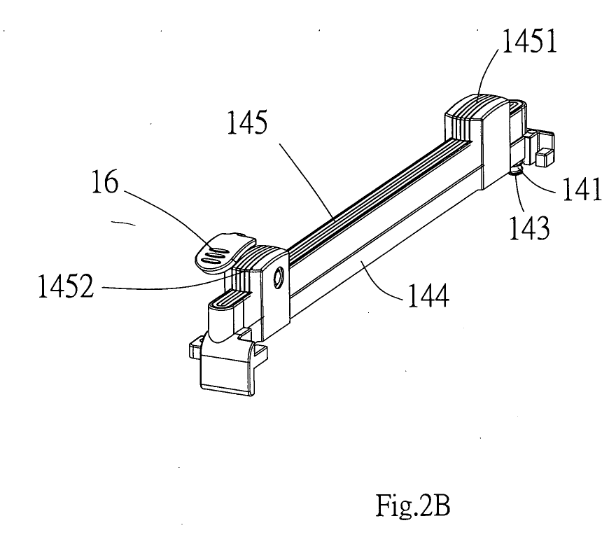

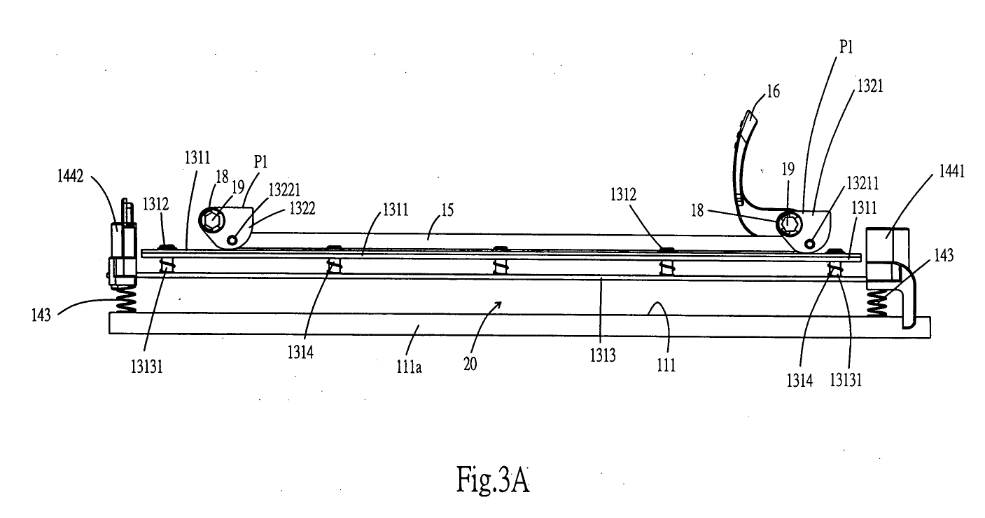

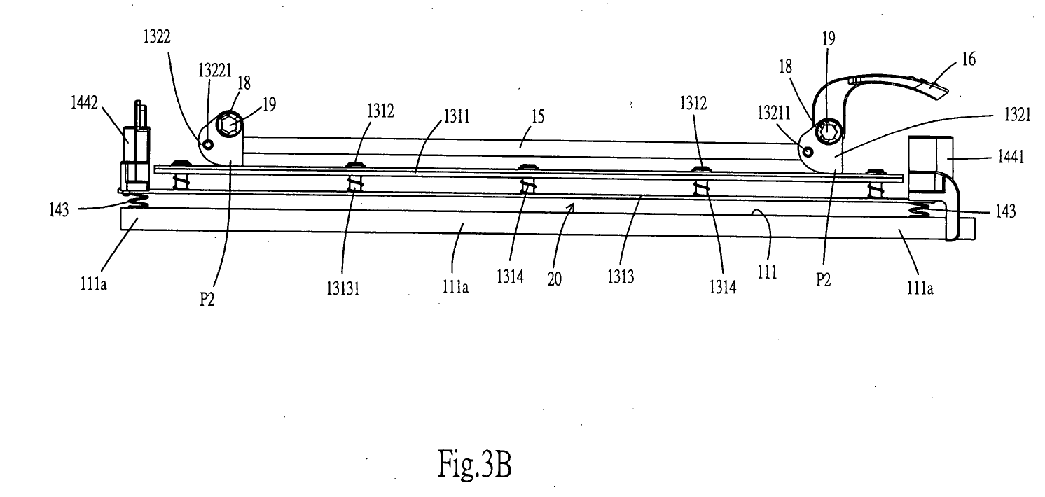

As shown in FIGS. 1(A) and 1(B), the cutting apparatus 10 of the present invention comprises a platform 11, a trimmer 12 and a pressing mechanism 13. The platform 11 has an article supporting surface 111 for placing thereon the sheet articles to be trimmed (not shown). Examples of these sheet articles include but are not limited to papers, photographs, plastic sheets, clothes or leathers. The trimmer 12 is disposed at a trimming edge 111a of the platform 11. The pressing mechanism 13 is disposed above the article supporting surface 111 and adjacent to the trimmer 12. Referring also to FIGS. 2(A) and 3(A), a receptacle 20 is disposed between a pressing plate member 131 of the pressing mechanism 13 and the article supporting surface 111 for accommodating the sheet articles.

An exemplary trimmer 12 is a knife, which has a first end 121 coupled to the trimming edge 111a of the platform 11 and used as a fulcrum of the knife such that the knife 12 can be pivoted about the trimming edge 111a. The knife 12 further comprises a stem 123 and a knife-edge 124. The stem 123 is disposed at a second end 122 of the knife 12. The knife-edge 124 is disposed between the first end 121 and the second end 122 of the knife 12, and in close contact with the trimming edge 111a. In a case that the stem 123 is moved downwardly, the knife-edge 124 cooperates with the trimming edge 111a to trim the sheet articles.

It is noted that, however, those skilled in the art will readily observe that numerous modifications and alterations of the trimmer may be made while retaining the teachings of the invention. For example, the trimmer 12 may be a sliding trimmer with sliding and trimming functions. Accordingly, the above disclosure should be limited only by the bounds of the following claims.

Referring to FIG. 2(A), an exploded diagram of a pressing mechanism according to a preferred embodiment is shown. Please also refer to FIGS. 1(A) and 1(B). The pressing mechanism 13 comprises the pressing plate member 131, two cams 1321 and 1322, a supporting member 14, a transmission rod 15 and a stirring handle 16. The pressing plate member 131 is disposed above the article supporting surface 111 and adjacent to the trimmer 12. These two cams 1321 and 1322 are disposed above the pressing plate member 131 and have protrusion posts 13211 and 13221 protruded from the same side of the cams 1321 and 1322, respectively. The supporting member 14 is fixed on the article supporting surface 111 for supporting the cams 1321 and 1322, and used as a fulcrum of the cams 1321 and 1322 such that the cams 1321 and 1322 can be pivoted about the supporting member 14. The transmission rod 15 is pivotally coupled to the protrusion posts 13211 and 13221 for driving the cams 1321 and 1322 to synchronously roll. In such manner, the cams 1321 and 1322 are downwardly sustained against the pressing plate member 131 so as to press the sheet articles accommodated within the receptacle 20 and facilitate a further trimming operation on the sheet articles. The stirring handle 16 is pivotally coupled to either of the cams 1321 and 1322, for example the cam 1322 as shown in FIG. 2(A). In response to an external force applying on the stirring handle 16, the transmission rod 15 is driven to move in reciprocation, and the rolling surfaces of the cams 1321 and 1322 are rolled on the pressing plate member 131 back and forth.

An exemplary pressing plate member 131 comprises an upper pressing plate 1311, a lower pressing plate 1313 and a plurality of resilience elements 1314. The upper pressing plate 1311 has a plurality of openings to have the corresponding screws 1312 penetrate therethrough. The lower pressing plate 1313 has a plurality of pillars 13131 at the locations corresponding to the screws 1312. Each pillar 13131 has a bolt hole to have a corresponding screw 1312 insert therein. The resilience elements 1314 are disposed between the upper pressing plate 1311 and the lower pressing plate 1313 and sheathed around the corresponding pillars 13131. Upon the cams 1321 and 1322 are downwardly sustained against the pressing plate member 131, the resilience elements 1314 will provide an elastic pressing effect.

In some preferred embodiments, the pillars 13131 are integrally formed with the lower pressing plate 1313. It is noted that, however, those skilled in the art will readily observe that numerous modifications and alterations of the pressing plate member may be made while retaining the teachings of the invention. For a purpose of minimizing the scrapes or scars on the sheet articles upon the pressing plate member 131 presses the sheet articles, a rubber pad 1315 may be optionally provided under the lower pressing plate 1313.

Please also refer to FIG. 2(A). Each of the cams 1321 and 1322 comprises a first cam part 1321a or 1322a, a second cam part 1321b or 1322b, and a curved connection part 13213. Each of the first cam part 1321a, 1322a and the second cam part 1321b, 1322b has a hole 13212 for a shaft 19 to penetrate therethrough. The curved connection part 13213 is coupled to portions of the rolling surfaces of the first cam part 1321a (or 1322a) and the second cam part 1321b (or 1322b), and integrally formed with the first cam part 1321a (or 1322a) and the second cam part 1321b (or 1322b) so as to form hollow cams 1321 and 1322. The protrusion posts 13211 and 13221 of the cams 1321 and 1322 are protruded from the same side of the first cam parts 1321a and 1322a, respectively.

It is noted that, however, those skilled in the art will readily observe that numerous modifications and alterations of the cams may be made while retaining the teachings of the invention. For example, three or more hollow cams can be used to replace the two cams 1321 and 1322. Alternatively, the hollow cams can be replaced with solid ones. Accordingly, the above disclosure should be limited only by the bounds of the following claims.

The relationship between the supporting member 14 and the two cams 1321 and 1322 will be illustrated as follows. The supporting member 14 has a strip-shaped receptacle 144 for accommodating the two cams 1321 and 1322 and thus the two cams 1321 and 1322 can be operated therein. There are two protrusion chambers 1441 and 1442 formed on the bilateral sides of the strip-shaped receptacle 144 and used for accommodating the two cams 1321 and 1322. The protrusion chambers 1441 and 1442 have holes 14411 and 14421, respectively. Each shaft 19 penetrates through the hole 13212 of the cam 1321 (or 1322) and the holes 14411 (or 14421) of the protrusion chamber 1441 (or 1442) so as to support the cams 1321 and 1322 and used as a fulcrum such that the cams 1321 and 1322 are pivoted about the shaft 19. Each end of the shaft are coupled with a screw nut 17 and an E-shaped ring 18 such that the two cams 1321 and 1322 are pivotally coupled to the protrusion chambers 1441 and 1442, respectively.

In addition, the strip-shaped receptacle 144 further comprises two props 141 and 142 disposed at opposite sides thereof and adjacent to the pressing plate member 131. Each of props 141 and 142 is sheathed by a resilience element 143.

The supporting member 14 further comprises a cover member 145 having two protrusion chambers 1451 and 1452 for covering the top portion of the strip-shaped receptacle 144. The assembly of the cover member 145, the strip-shaped receptacle 144 and the stirring handle 16 coupled to the cam 1322 is illustrated in FIG. 2(B).

It is noted that, however, those skilled in the art will readily observe that numerous modifications and alterations of the supporting member may be made while retaining the teachings of the invention. Accordingly, the above disclosure should be limited only by the bounds of the following claims.

The relationship between the two cams 1321 and 1322 and the pressing plate member 131 will be illustrated with reference to FIGS. 3(A) and 3(B). In FIG. 3(A), the cams 1321 and 1322 have not been sustained against the pressing plate member 131 to perform the pressing operation. Whereas, in FIG. 3(B), the cams 1321 and 1322 have been sustained against the pressing plate member 131 so as to perform the pressing operation. By the way, the pressing plate member 131 is movably clamped between the props 141 and 142 and supported by the two resilience elements 143, as can be seen in FIG. 2(A). As shown in FIG. 3(A), each of the two cams 1321 and 1322 rests on the pressing plate member 131 at an initial position P1, but is not sustained against the pressing plate member 131 to perform the pressing operation. Once the stirring handle 16 is depressed down, each of the two cams 1321 and 1322 is rolled from the initial position P1 to a pressing position P2 so as to be sustained against the pressing plate member 131. Meanwhile, the pressing plate member 131 will move downwardly along the props 141 and 142, thereby compressing the resilience elements 143. On the other hand, when the stirring handle 16 is lifted up, the recovery elastic force generated from the compressed resilience elements 143 will uplift the pressing plate member 131 to the original state as shown in FIG. 3(A), thereby exposing the receptacle 20 between the pressing plate member 131 and the article supporting surface 111.

In the above embodiments, due to the pressing effect resulting from the back and forth rolling operations of the cams 1321 and 1322, the amount of movement of the pressing plate member 131 is about 7˜8 cm, which is approximately equal to the thickness of 25 standard paper sheets. In contrast, the amount of movement provided by the pressing mechanism of conventional cutting apparatus is about 2˜3 cm. Therefore, the pressing mechanism of the present invention can provide enhanced pressing effect.

From the above description, the pressing mechanism of the present invention is capable of offering an enhanced pressing force so as to be applied to the cutting apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to compass all such modifications and similar structures.

What is claimed is:

1. A pressing mechanism of a cutting apparatus, said cutting apparatus comprising a platform having an article supporting surface and a trimmer, said pressing mechanism comprising:
a pressing plate member disposed above said article supporting surface and adjacent to said trimmer, wherein a receptacle is formed between said pressing plate member and said article supporting surface so as to accommodate a sheet article;
at least two cams disposed above said pressing plate member and having respective protrusion posts protruded from the same side thereof;
a supporting member fixed on said article supporting surface for supporting said at least two cams and used as a fulcrum such that said at least two cams are pivoted about said supporting member; and
a transmission member having a transmission rod pivotally coupled to said protrusion posts for driving said at least two cams to synchronously roll and allowing said at least two cams to be downwardly sustained against said pressing plate member, thereby pressing said sheet article accommodated within said receptacle and facilitating a further trimming operation on said sheet article.

2. The pressing mechanism according to claim 1 wherein said trimmer is a knife, which has a first end coupled to a trimming edge of said platform and used as a fulcrum of said knife such that said knife is pivoted about said trimming edge.

3. The pressing mechanism according to claim 2 wherein said knife further comprises:
a stem disposed at a second end of said knife; and
a knife-edge disposed between said first and second ends of said knife, and in close contact with said trimming edge, wherein said knife-edge cooperates with said trimming edge to trim said sheet article when said stem is moved downwardly.

4. The pressing mechanism according to claim 1 wherein said pressing plate member comprises:
an upper pressing plate having a plurality of openings to have corresponding screws penetrate therethrough; and
a lower pressing plate having a plurality of pillars corresponding to said screws, each pillar having a bolt hole for a corresponding screw to insert therein.

5. The pressing mechanism according to claim 4 wherein said pressing plate member further comprises a plurality of resilience elements disposed between said upper pressing plate and said lower pressing plate and sheathed around said pillars, wherein said resilience elements provide an elastic pressing effect when said at least two cams are downwardly sustained against said pressing plate member.

6. The pressing mechanism according to claim 4 wherein said pillars are integrally formed with said lower pressing plate.

7. The pressing mechanism according to claim 4 wherein said pressing plate member further comprises a rubber pad under said lower pressing plate.

8. The pressing mechanism according to claim 1 wherein each cam comprises:
first and second cam parts having first holes for a shaft to penetrate therethrough; and
a curved connection part coupled to portions of the rolling surfaces of said first and cam parts, and integrally formed with said first and second cam parts so as to form hollow cams.

9. The pressing mechanism according to claim 8 wherein said supporting member further comprises second holes, and each shaft penetrates through said first holes of each cam and said second holes of said supporting member so as to support said at least two cams and be used as a fulcrum such that said at least two cams are pivoted about said shaft.

10. The pressing mechanism according to claim 1 wherein each cam is a solid cam having first holes for a shaft to penetrate therethrough.

11. The pressing mechanism according to claim 10 wherein said supporting member further comprises second holes, and each shaft penetrates through said first holes of each cam and said second holes of said supporting member so as to support said at least two cams and be used as a fulcrum such that said at least two cams are pivoted about said shaft.

12. The pressing mechanism according to claim 1 wherein said supporting member further comprises two props disposed at bilateral sides thereof, adjacent to said pressing plate member, and fixed on said article supporting surface, wherein each of said two props is sheathed by a resilience element.

13. The pressing mechanism according to claim 12 wherein said pressing plate member is movably clamped between said two props and supported by said two resilience elements, wherein said pressing plate member moves downwardly along said two props to compress said two resilience elements when said at least two cams are sustained against said pressing plate member, and the recovery elastic force generated from said compressed resilience elements uplifts said pressing plate member to the original state to expose said receptacle between said pressing plate member and said article supporting surface when said at least two cams have not been sustained against said pressing plate member.

14. The pressing mechanism according to claim 1 wherein said transmission member further comprises a stirring handle pivotally coupled to either of said at least two cams, wherein in response to an external force applying on said stirring handle, said transmission rod is driven to move in reciprocation and the rolling surfaces of said at least two cams are rolled on the pressing plate member back and forth.

15. A cutting apparatus for trimming a sheet article, comprising:
a platform having an article supporting surface for placing thereon said sheet article;
a trimmer disposed on a trimming edge of said platform; and
a pressing mechanism disposed above said article supporting surface and adjacent to said trimmer, and comprising a pressing plate member, at least two cams and a transmission rod, wherein a receptacle is formed between said pressing plate member and said article supporting surface so as to accommodate said sheet article, said at least two cams have respective protrusion posts protruded from the same side thereof, and said transmission rod is pivotally coupled to said protrusion posts for driving said at least two cams to synchronously roll and allowing said at least two cams to be downwardly sustained against said pressing plate member, thereby pressing said sheet article accommodated within said receptacle and facilitating a further trimming operation on said sheet article.
